(19) United States
(12) Patent Application Publication
(10) Pub. No.: US 2004/0107388 A1
(43) Pub. Date: Jun. 3, 2004

(54) Microcomputer

(75) Inventor: Masayuki Konishi, Tokyo (JP)

Correspondence Address: BURNS, DOANE, SWECKER & MATHIS, L.L.P., P.O. Box 1404, Alexandria, VA, 22313-1404, US

(73) Assignee: RENESAS TECHNOLOGY CORP.

(21) Appl. No.: 10/431,496

(22) Filed: May 8, 2003

(30) Foreign Application Priority Data
Nov. 29, 2002 (JP) 2002-347780

(51) Int. Cl. G06F 11/00

(52) U.S. Cl. 714/43

(57) ABSTRACT

A CPU of a microcomputer according to the present invention executes a write operation for setting data in a special function register (SFR) while a peripheral enable signal is asserted, and then asserts the peripheral enable signal for one more cycle. By doing so, a peripheral read/write signal becomes effective and the SFR outputs the data set during the write operation onto a peripheral data bus. Therefore, it is possible to check whether the data is successfully written in the SFR within a shorter period of time by automatically executing a read instruction immediately after a write instruction is executed.

### BACKGROUND OF THE INVENTION

1) Field of the Invention

The present invention relates to a microcomputer having a function of checking the content of a register that designates an operation to be executed to a peripheral module.

2) Description of the Related Art

Recently, microcomputers have been diversified to those each of which realizes the acceleration of a central processing unit (CPU), the mass storage of a memory, and the inclusion of peripherals following extended applications therefor. Peripherals include a timer, an analog-to-digital (A/D) converter, and a digital-to-analog (D/A) converter. In the timer, for example, an operation mode is set in an operation mode setting register of the timer to determine whether the frequency of a basic clock that actuates the timer by a program executed by the CPU or the timer is employed at one time or free running.

Peripherals of the microcomputer operate in accordance with a value set in the operation mode setting register. This requires checking data after the data is set in the operation mode setting register.

A conventional microcomputer includes an interface section that interfaces with an external peripheral hardware. The interface section, the CPU, and an operation mode setting register for peripherals are alternately connected to one another through a bus. If the CPU sets data in the operation mode setting register or refers to the data in the operation mode setting register, the data in the operation mode setting register is checked at real time through the interface section. This is disclosed in, for example, Japanese Patent Application Laid-Open No. 02-310636.

According to the conventional art, however, the data in the operation mode setting register is checked from the outside of the microcomputer. Therefore, the program of the microcomputer is unable to check the data in a special function register (SFR) although the program is effective in checking the data at debugging. Therefore, it is necessary to refer to the data in the SFR in order to check the data after the data is set in the SFR by the debugged program. Namely, it is necessary to execute a read instruction to refer to the data in the SFR after a write instruction is executed so as to set the data in the operation mode setting register.

If executing an instruction, the CPU alternately repeats instruction fetches for accessing a memory area where the instruction is stored and execution of an arithmetic operation or execution of an instruction such as write/read of data to/from the operation mode setting register. If it is necessary to execute the instruction fetches five times in order to read data with respect to a write instruction to write data to the operation mode setting register, a read instruction for checking whether the data is successfully written to the operation mode setting register is executed after five cycles. This disadvantageously takes a lot of time.

Further, two instructions of a write instruction and a read instruction are required, that disadvantageously increases the capacity of a read only memory (ROM) or a random access memory (RAM) that serves as a program area.

### SUMMARY OF THE INVENTION

It is an object of this invention to obtain a microcomputer capable of automatically executing a read instruction right after executing a write instruction to write data to an operation mode setting register, and checking the data written thereto.

The microcomputer according to one aspect of this invention includes a central processing unit (CPU) that executes instructions, an instruction storage memory that stores the instructions to be executed by the CPU, one or more operation mode setting registers each in which an operation mode for a peripheral module is set, and a bus interface unit connected to the instruction storage memory by a memory bus, and connected to the one or more operation mode setting registers by a peripheral bus. By executing a write operation in accordance with a write instruction to set data in predetermined one of the operation mode setting registers while a peripheral enable signal is asserted, and executing a read operation by asserting the peripheral enable signal for one more cycle after the write operation is executed, the CPU outputs the data set through the write operation to a peripheral data bus of the peripheral bus in an instruction fetch period in which a next instruction is read from the instruction storage memory through the bus interface unit.

The microcomputer according to another aspect of this invention includes a central processing unit (CPU) that executes instructions, an instruction storage memory that stores the instructions to be executed by the CPU, and one or more operation mode setting registers each in which an operation mode for a peripheral module is set. The microcomputer also includes a bus interface unit connected to the instruction storage memory by a memory bus and connected to the one or more operation mode setting registers by a peripheral bus, a first test register connected to the bus interface unit by a dedicated data bus, and a second test register connected to the bus interface unit by a peripheral data bus of the peripheral bus. The CPU executes a write operation in accordance with a write instruction to set data in predetermined one of the operation mode setting registers while a peripheral enable signal is asserted, and then outputs a signal for asserting the peripheral enable signal for two -more cycles after the write operation is executed. During the write operation, the CPU sets identical data in the predetermined operation mode setting register and the first test register, and the first test register sets inverted data of the data set therein in the second test register. The second test register outputs the set data onto the peripheral data bus during a read operation in a next cycle to the write operation, and the predetermined operation mode setting register outputs the set data onto the peripheral data bus during a read operation in a further next cycle to the write operation.

These and other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 shows a block diagram of the configuration of a microcomputer according to a first embodiment of the present invention,

FIG. 2 shows a time chart of the operation of the microcomputer according to the first embodiment,

FIG. 3 shows a block diagram of the configuration of a microcomputer according to a second embodiment of the present invention,

FIG. 4 shows a block diagram of the configuration of a microcomputer according to a third embodiment of the present invention,

FIG. 5 shows a block diagram of the configuration of a microcomputer according to a fourth embodiment of the present invention,

FIG. 6 shows a time chart of the operation of the microcomputer according to the fourth embodiment, and

FIG. 7 shows a block diagram of the configuration of a microcomputer according to a fifth embodiment of the present invention.

### DETAILED DESCRIPTION

Embodiments of the microcomputer according to the present invention will be explained in detail below with reference to the accompanying drawings.

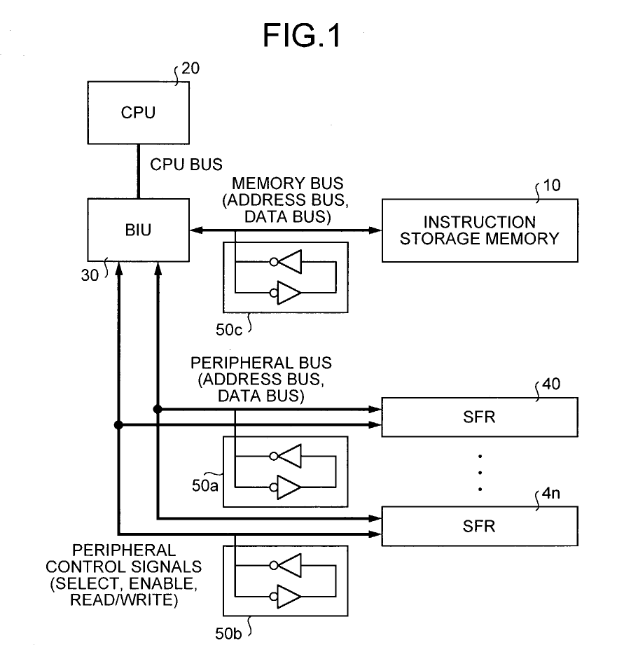

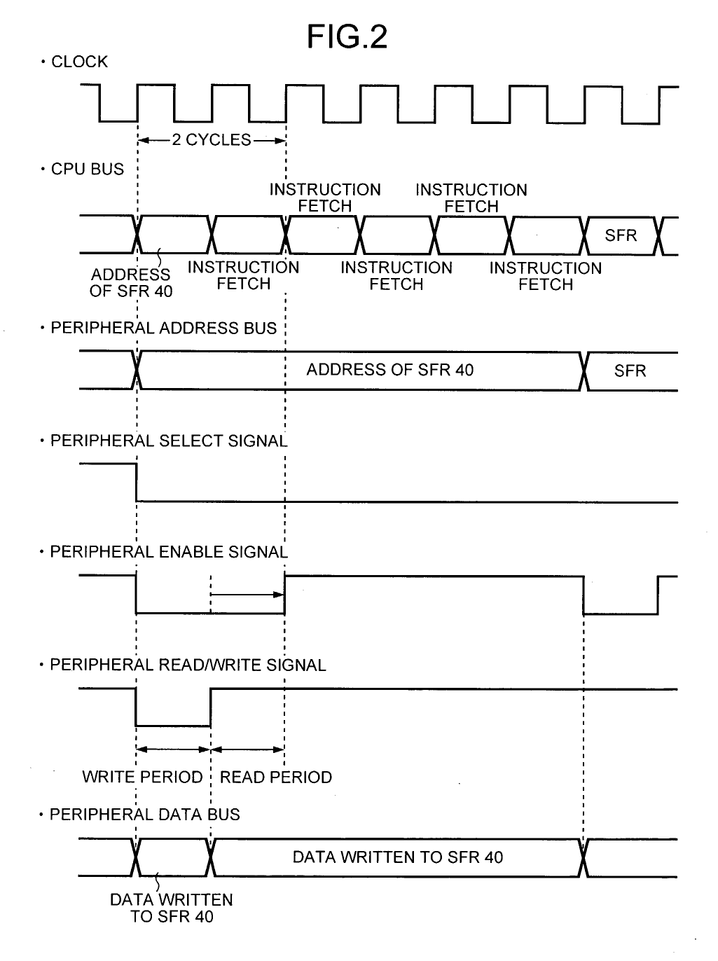

A first embodiment of the present invention will be explained below with reference to FIGS. 1 to 2. FIG. 1 shows a block diagram of the configuration of a microcomputer in the first embodiment. The microcomputer in this embodiment includes an instruction storage memory 10, a CPU 20, a bus interface unit (BIU) 30, a plurality of peripheral modules (n peripheral modules in this case), operation mode setting registers SFRs 40 to 4n for the respective peripheral modules, and latch circuits 50a to 50c.

The instruction storage memory 10 consists of a ROM and a RAM, and stores programs executed by the CPU 20, that is, instructions executed by the CPU 20.

The SFRs 40 to 4n are the operation mode setting registers for the respective peripheral modules such as a timer, an A/D converter, and a D/A converter. The SFRs 40 to 4n are allocated to specific address areas, respectively.

The CPU 20 reads an instruction stored in the instruction storage memory 10 through the BIU 30, and performs an arithmetic operation in accordance with the instruction. If the instruction is a write instruction or a read instruction to or from one of the SFRs 40 to 4n, the CPU 20 outputs a peripheral bus signal and a peripheral control signal through the BIU 30. Specifically, if a specific address area to which one of the SFRs 40 to 4n is allocated, is to be designated, the CPU 20 asserts a peripheral select signal. In other words, if the address area of one of the SFRs 40 to 4n is designated, the peripheral select signal is generated by decoding the address area and kept asserted until the address of the peripheral address bus changes. In addition, the CPU 20 asserts a peripheral enable signal in cycles necessary to execute a write operation or a read operation for writing or reading data to or from one of the SFRs 40 to 4n indicated by the address on the peripheral address bus. A peripheral read/write signal normally indicates the read operation (high level (“H”) in this case) and is set at low level (“L”) in the necessary cycles during the write operation. That is, by asserting the peripheral select signal and the peripheral enable signal, the CPU 20 selects one of the SFRs 40 to 4n, and executes the write operation or read operation for the selected SFR.

The BIU 30, which is a bus interface, is connected to the instruction storage memory 10 by a memory bus (which includes an address bus and a data bus). The BIU 30 is also connected to the SFRs 40 to 4n by the peripheral bus (which includes the peripheral address bus and a peripheral data bus) and the peripheral control signals (peripheral select signal, peripheral enable signal, and peripheral read/write signal), respectively. The BIU 30 is connected to the CPU 20 by a CPU bus. The BIU 30 identifies whether the address designated by the CPU 20 is a memory address or a peripheral address, and accesses the instruction storage memory 10 or one of the SFRs 40 to 4n. Generally, the memory bus and the peripheral bus are provided separately so as to accelerate the operation of the microcomputer. However, the present invention is not limited to this.

The latch circuit 50a is connected to the peripheral bus and latches data on the peripheral bus until the data on the peripheral bus changes. The latch circuit 50b is connected to the peripheral control signals and latches data on the peripheral bus until the peripheral control signals change. The latch circuit 50c is connected to the memory bus and latches data on the memory bus until the data on the memory bus changes.

Referring to the time chart of FIG. 2, the instruction operation of the microcomputer in the first embodiment for writing data to the SFR 40 and checking the written data will be explained. A clock CLK is a basic signal for the operation of the microcomputer in the first embodiment. The memory bus signal, peripheral bus signal, and peripheral control signal change synchronously with the clock CLK.

The CPU 20 reads an instruction stored in the instruction storage memory 10 through the BIU 30, and outputs the address of the SFR 40 to the CPU bus so as to perform a write operation for writing data to the SFR 40. The BIU 30 identifies that the address on the CPU bus is the address of the SFR 40, and outputs the address of the SFR 40 to the peripheral address bus.

The CPU 20 asserts the peripheral select signal (“L” in this case), and asserts the peripheral enable signal for the SFR 40 (“L” in this case). The CPU 20 also sets the peripheral read/write signal for the SFR 40 to “L”. The CPU 20 outputs data to be written to the SFR 40, to the peripheral data bus through the BIU 30. Since all the peripheral select signal, the peripheral enable signal, and the peripheral read/write signal are set at “L”, the data on the peripheral data bus is written to the SFR 40.

After one cycle that is a write period in which the data is written to the SFR 40 ends, the CPU 20 sets the peripheral read/write signal to “H”. The CPU 20 extends the cycles of the peripheral enable signal by one cycle. That is, after the peripheral read/write signal changes from “L” to “H”, the CPU 20 sets the peripheral enable signal to “L” for one cycle for performing the next instruction fetch. As a result, the “H” level of the peripheral read/write signal becomes effective, and the data is read from the SFR 40 and output onto the peripheral data bus.

As explained above, according to the first embodiment, the peripheral enable signal is kept asserted for one more cycle after the write operation is executed. It is, therefore, possible to simultaneously perform the next instruction fetch and execute the read operation for reading the data written to the SFR 40 during the write operation. It is thus possible to check the data written to the operation mode setting register for the peripheral module.

The CPU 20 may execute the instruction to extend the cycles of the peripheral enable signal by one cycle after the write operation for writing data to one of SFRs 40 to 4n is performed in accordance with the peripheral read/write signal, by an ordinary write instruction. Alternatively, the CPU 20 may add a new instruction and extend the cycles of the peripheral enable signal by one cycle if the new instruction is to be executed. This can make the instructions executed by the CPU more flexible.

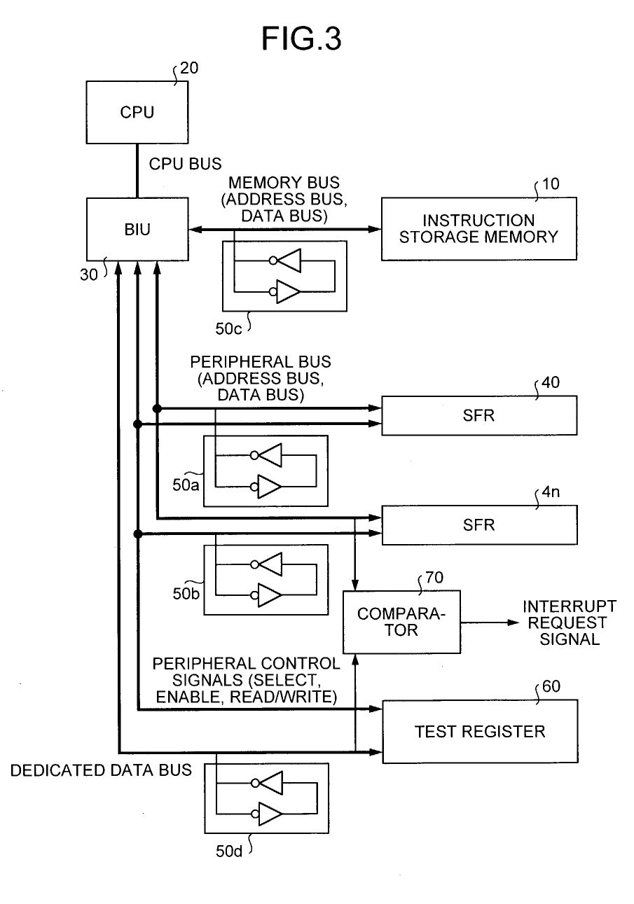

A second embodiment of the present invention will be explained below with reference to FIG. 3. FIG. 3 shows a block diagram of the configuration of a microcomputer in the second embodiment. The microcomputer in the second embodiment includes a test register 60, a latch circuit 50d, and a comparator 70 in addition to the constituent elements of the microcomputer shown in FIG. 1. The constituent elements the same in function as those in the first embodiment are denoted by the same reference numerals and will not be explained herein repeatedly.

The test register 60 is connected to the BIU 30 by a dedicated data bus. The same data as that written to one of the SFRs 40 to 4n when a write operation is executed to the SFR, is written to the test register 60. That is, if the data is written to one of the SFRs 40 to 4n through the BIU 30, the CPU 20 outputs the same data onto the peripheral data bus and the dedicated data bus, and the data on the dedicated data bus is written to the test register 60.

The latch circuit 50d is connected to the dedicated data bus and holds the data on the dedicated data bus until the data on the dedicated data bus changes.

The comparator 70 compares the data on the peripheral data bus with the data on the dedicated data bus. If the comparison result indicates that the two pieces of data do not coincide, the comparator 70 outputs an interrupt request signal to the CPU 20.

The operation of the microcomputer in the second embodiment will be explained below. The CPU 20 executes a write instruction. Accordingly, the BIU 30 outputs the address of the SFR 40 onto the peripheral address bus. The CPU 20 sets the peripheral select signal to “L”, and sets the peripheral enable signal and peripheral read/write signal for the SFR 40 to “L”. These signals are output to the SFR 40 through the BIU 30. The CPU 20 outputs the same data onto the peripheral data bus and the dedicated data bus through the BIU 30. Accordingly, the write operation is executed and the data is written to both the SFR 40 and the test register 60.

The CPU 20 sets the peripheral read/write signal to “H”. Since the peripheral enable signal is at “L”, the read operation is executed. Accordingly, the SFR 40 outputs the data written to the SFR 40 during the write operation to the comparator 70 through the peripheral address bus. In addition, the test register 60 outputs the data written to the test register 60 during the write operation to the comparator 70 through the dedicated data bus. These pieces of data are held by the latch circuits 50a and 50d respectively until one of the SFRs 40 to 4n is accessed the next time.

The comparator 70 compares the data on the peripheral address bus with the data on the dedicated data bus. That is, the comparator 7 compares the data written to the SFR 40 with the data written to the test register 60. If the comparison result indicates that the two pieces of data do not coincide, the comparator 70 outputs an interrupt request signal to the CPU 20.

The instruction storage memory 10 stores the interrupt processing program. The CPU 20 executes the interrupt processing program stored in the instruction storage memory 10 based on the interrupt request signal.

As explained above, according to the second embodiment, the microcomputer includes the test register. In the write operation, the same data is written to one of the operation mode setting registers for a peripheral module and the test register, and the two pieces of data are read after the write operation and compared with each other. If the comparison result indicates that they do not coincide, the interrupt request signal is output. It is, therefore, possible to check whether the write operation for writing data to one of the operation mode setting registers is performed correctly and to perform a processing if the data written to the operation mode setting register does not coincide with the data written to the test register.

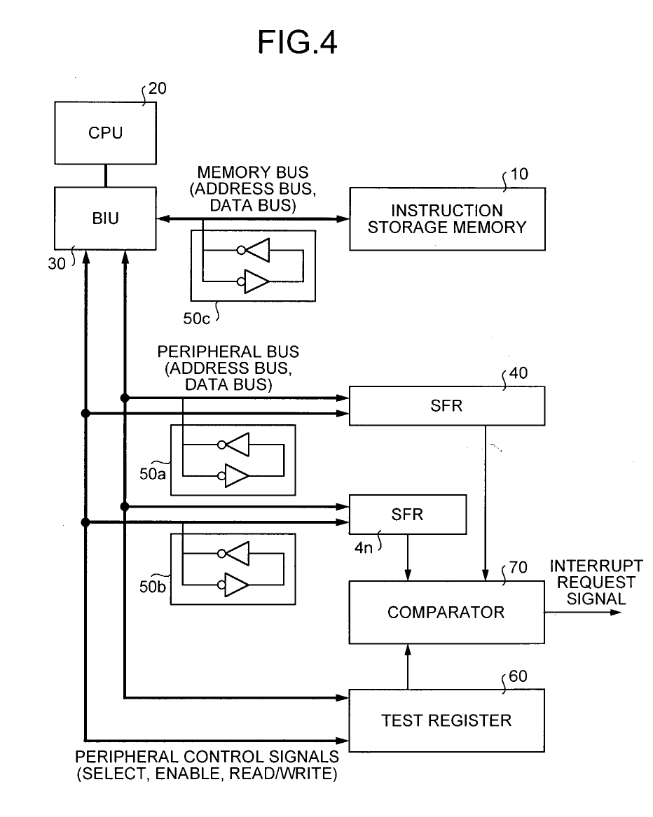

A third embodiment of the present invention will be explained below with reference to FIG. 4. In the second embodiment, the data read from one of the operation mode setting registers onto the peripheral data bus is compared with the data read from the test register onto the dedicated data bus, thereby checking whether the data is successfully written to the operation mode setting register. In the second embodiment, however, the dedicated data bus for writing data to the test register 60 is necessary, that disadvantageously increases the number of wirings.

In this third embodiment, in order to solve this problem, the test register is connected to the peripheral bus to which the operation mode setting registers are connected. The data written to the operation mode setting registers is then checked.

FIG. 4 shows a block diagram of the configuration of a microcomputer in the third embodiment. In the microcomputer of the third embodiment, the test register 60 is connected to the peripheral bus, and the outputs of the SFRs 40 to 4n and the output of the test register 60 are input to the comparator 70. The constituent elements the same in function as those in the second embodiment are denoted by the same reference numerals and will not be repeatedly explained herein.

The operation of the microcomputer in the third embodiment will be explained below. The CPU 20 executes a write instruction, that is, the CPU 20 outputs the address of the SFR 40 onto the CPU bus. Accordingly, the BIU 30 outputs the address of the SFR 40 onto the peripheral address bus. The CPU 20 sets the peripheral select signal to “L”, and sets the peripheral enable signal and peripheral read/write signal for the SFR 40 to “L”. These signals are output to the SFR 40 and the test register 60 through the BIU 30. The CPU 20 outputs data to be written to the SFR 40, onto the peripheral data bus through the BIU 30. As a result, the write operation is executed, and the data is written to the SFR 40 and the test register 60.

The CPU 20 sets the peripheral read/Write signal to “H”. Since the peripheral enable signal is at “L”, a read operation is executed. As a result, the SFR 40 and the test register 60 output their respective pieces of data written thereto during the write operation, to the comparator 70.

The comparator 70 compares the data input from the SFR 40 with the data input from the test register 60. If the comparison result indicates that the two pieces of data do not coincide, the comparator 70 outputs an interrupt request signal to the CPU 20.

The instruction storage memory 10 stores an interrupt processing program. The CPU 20 executes the interrupt processing program stored in the instruction storage memory 10 based on the interrupt request signal.

As explained above, according to the third embodiment, the test register is connected to the peripheral bus to which the operation mode registers are connected. In the write operation, the same data is written to one of the target operation mode setting registers and the test register, and then the data written to the operation mode setting register is compared with the data written to the test register. It is, therefore, possible to check whether the data is successfully written to the operation mode setting register with a small number of wirings without using the data bus dedicated to the test register.

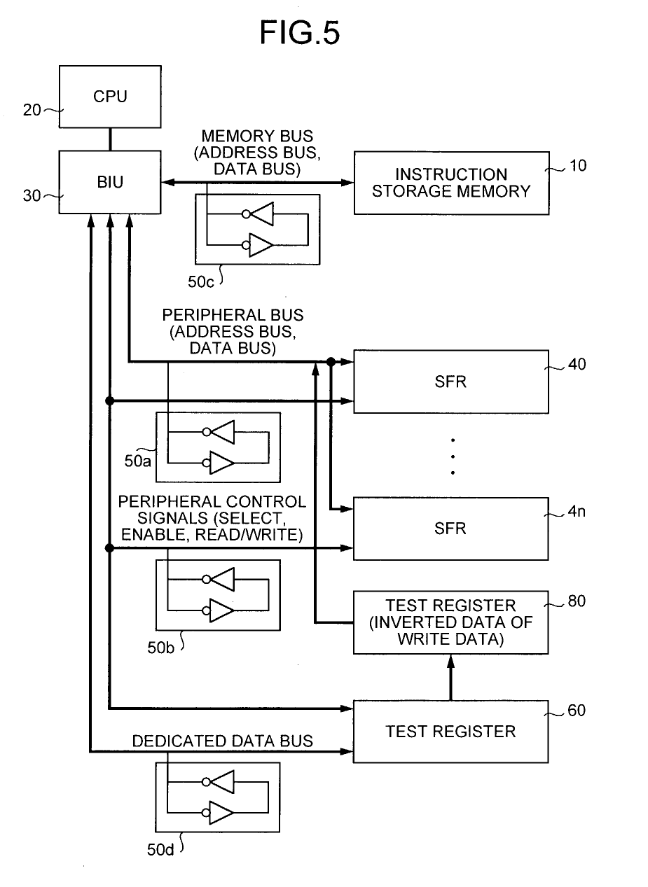

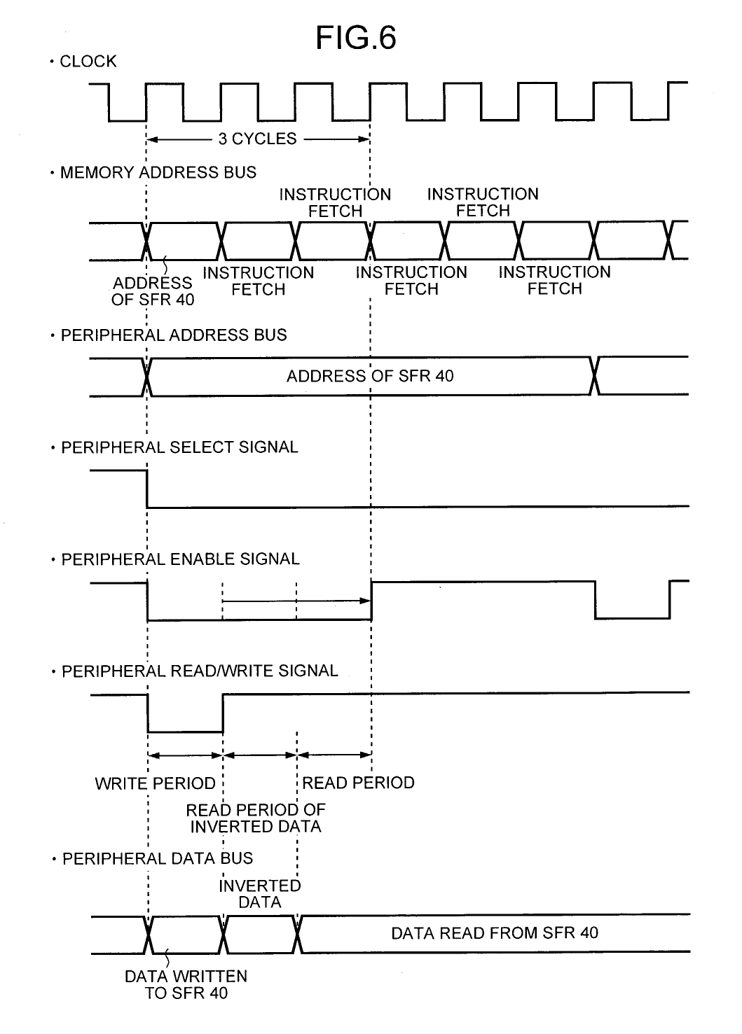

A fourth embodiment of the present invention will be explained below with reference to FIG. 5 and FIG. 6. In the first to third embodiments, the peripheral enable signal is asserted for one more cycle after the write operation is executed, so that the next instruction fetch and the read operation for reading the data written to the SFR during the write operation are performed simultaneously. If so, however, the frequency of the clock that serves as the basic signal for the operation of the microcomputer becomes high. Therefore, if the length of one cycle is shortened, a margin cannot be secured for a read operation for reading data from one of the operation mode setting registers. That is, the data written to the operation mode setting register during the write operation cannot be often read correctly.

In order to solve this problem, the microcomputer in the fourth embodiment includes two test registers 60 and 80. By asserting the peripheral enable signal for two cycles after a write operation is executed, thereby a read operation margin can be secured.

FIG. 5 shows a block diagram of the configuration of the microcomputer in the fourth embodiment. The microcomputer in the fourth embodiment includes the test registers 60 and 80 in addition to the constituent elements of the microcomputer shown in FIG. 1. The constituent elements the same in function as those in the first embodiment are denoted by the same reference numerals and will not be repeatedly explained herein.

The test register 60 is connected to the BIU 30 by the dedicated data bus. The same data as the data written to one of the SFRs 40 to 4n during the write operation, is written to the test register 60. That is, if the data is written to one of the SFRs 40 to 4n through the BIU 30, then the CPU 20 outputs the same data onto the peripheral data bus and the dedicated data bus, and the data on the dedicated data bus is written to the test register 60.

Inverted data of the data written to the test register 60 is written to the test register 80.

The operation of the microcomputer in the fourth embodiment will be explained below with reference to FIG. 6. The CPU 20 executes a write instruction, that is, the CPU 20 outputs the address of the SFR 40 onto the CPU bus. Accordingly, the BIU 30 outputs the address of the SFR 40 onto the peripheral address bus. The CPU 20 sets the peripheral select signal to “L”, and sets the peripheral enable signal and peripheral read/write signal for the SFR 40 to “L”. These signals are output to the SFR 40 and the test register 60 through the BIU 30. The CPU 20 outputs the same data onto the peripheral data bus and the dedicated data bus through the BIU 30. As a result, the write operation is executed and the data is written to the SFR 40 and the test register 60.

The tester register 60 writes the inverted data of the data written thereto, to the test register 80. That is, in a write period, the data on the peripheral bus is written to the test register 60 and the inverted data of the data on the peripheral bus is written to the test register 80.

The CPU 20 sets the peripheral read/write signal to “H”. Since the peripheral enable signal is at “L”, a read operation is executed. Accordingly, the test register 80 outputs the data written during the write operation onto the peripheral data bus. The CPU 20 sets the peripheral enable signal to “L” for one more cycle. That is, the CPU 20 sets the peripheral enable signal to “L” for two cycles after the peripheral read/write signal changes from “L” to “H”. As a result, the “H” level of the peripheral read/write signal becomes effective, and the SFR 40 outputs the data written thereto onto the peripheral data bus.

As explained above, according to the fourth embodiment, the microcomputer includes the two test registers. In the write operation, the same data is written to one of the operation mode setting registers and one of the test registers, and the inverted data of the data written to the operation setting mode register is written to the other test register. After the write operation is executed, the peripheral enable signal is asserted for two more cycles. In the first cycle, the inverted data is read. In the next cycle, the data written to the operation mode setting register is read and output onto the peripheral data bus. By doing so, the read operation for reading the inverted data is inserted between the write operation for writing data to one of the operation mode setting registers and the read operation for reading the written data. It is thereby possible to secure a read operation margin for reading data from the operation mode setting register, and to prevent data inconsistency due to the insufficient read operation margin.

In the read operation for reading the data from the operation mode setting register, the data may be read from one of the test registers to which the same data as that written to the operation mode setting register is written, and an interrupt request may be issued if the two pieces of data are compared and they do not coincide with each other. By doing so, it is possible to check whether the write operation for writing data to one of the operation mode setting registers is performed correctly, and to perform a processing if the two pieces of data are inconsistent.

The test registers may be connected to the peripheral data bus without using the dedicated data bus. By doing so, it is possible to secure a read operation margin for reading data from the operation mode setting register with a small number of wirings, and to prevent data inconsistency due to the insufficient read operation margin.

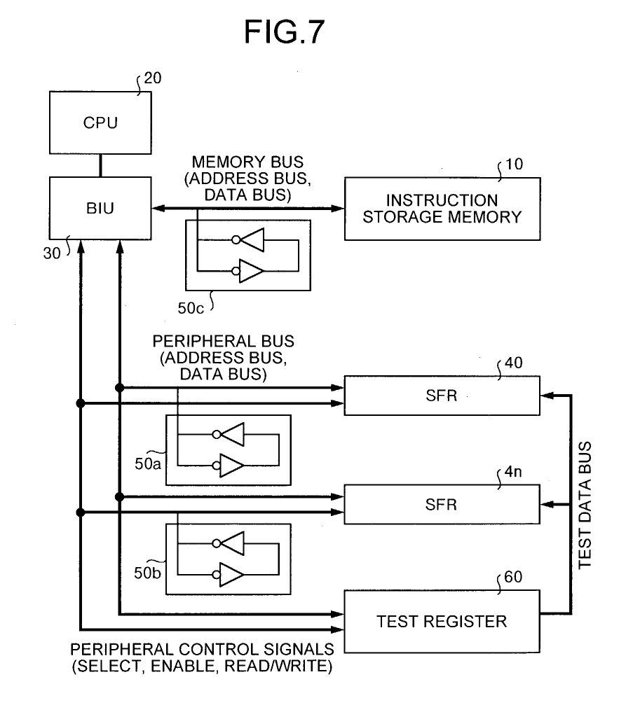

A fifth embodiment of the present invention will be explained below with reference to FIG. 7. In the fifth embodiment, data is written to a plurality of operation mode setting registers using the test register, and the operation mode setting registers are tested.

FIG. 7 shows a block diagram of the configuration of a microcomputer in the fifth embodiment. In the microcomputer of the fifth embodiment, the test register 60 and the SFRs 40 to 4n are connected to each other by a test data bus. The constituent elements of the microcomputer in this embodiment the same in function as those in the third embodiment are denoted by the same reference numerals and will not be repeatedly explained herein.

The CPU 20 executes a write operation, that is, the CPU 20 outputs test data onto the peripheral data bus through the BIU 30, and writes the test data to the test register 60. In the next cycle to the write operation, the test register 60 outputs the test data to the test data bus, and the test data is written to the SFRs 40 to 4n. That is, in a period in which an instruction fetch is performed in order to execute the next instruction, the data written to the test register 60 is simultaneously written to the SFR 40 to 4n.

The CPU 20 executes read instructions to the SFRs 40 to 4n, respectively, and reads data from the SFRs 40 to 4n to check the data written to the SFRs 40 to 4n.

As explained above, according to the fifth embodiment, the test register and the operation mode setting registers are connected to one another by the test data bus. In the next cycle to the write operation for writing data to the test register, the same data is simultaneously set in the operation mode setting registers. Therefore, it is possible to test the operation mode setting registers without the need to individually set data in the operation mode setting registers, and to thereby reduce the test time.

The CPU 20 may execute the instruction to extend the cycles of the peripheral enable signal by one cycle after performing a write operation for writing data to one of the SFR 40 to 4n in accordance with the peripheral read/write signal, by an ordinary write instruction. Alternatively, the CPU 20 may add a new instruction to extend the cycles of the peripheral enable signal by one cycle if the new instruction is to be executed. This can make the instructions executed by the CPU more flexible.

As explained so far, in the microcomputer according to the present invention, the peripheral enable signal is asserted for one more cycle after the write operation is executed. Therefore, the next instruction fetch and the read operation for reading the data written during the write operation are simultaneously performed. It is thereby possible to check whether the data is successfully written to the operation mode setting register for the peripheral module without executing the read instruction after the write instruction.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A microcomputer comprising:
a central processing unit (CPU) that executes instructions;
an instruction storage memory that stores the instructions to be executed by the CPU;
at least one of operation mode setting registers each in which an operation mode for a peripheral module is set; and
a bus interface unit connected to the instruction storage memory by a memory bus, and connected to the operation mode setting registers by a peripheral bus, wherein
by executing a write operation in accordance with a write instruction to set data in predetermined one of the operation mode setting registers while a peripheral enable signal is asserted, and executing a read operation by asserting the peripheral enable signal for one more cycle after the write operation is executed,
the CPU outputs the data set through the write operation to a peripheral data bus of the peripheral bus in an instruction fetch period in which a next instruction is read from the instruction storage memory through the bus interface unit.

2. The microcomputer according to claim 1, further comprising:
a test register in which the same data as the data set in the predetermined operation mode setting register is set during the write operation, and that outputs the set data during the read operation; and
a comparator that compares the data output from the predetermined operation mode setting register with the data output from the test register during the read operation, and outputs an interrupt request signal to the CPU if a result of the comparison indicates data inconsistency.

3. The microcomputer according to claim 2, wherein
the test register is connected to the bus interface unit by a dedicated data bus, and
the comparator compares the data output onto the peripheral data bus by the predetermined operation mode setting register with the data output onto the dedicated data bus by the test register during the read operation.

4. The microcomputer according to claim 2, wherein
the test register is connected to the bus interface unit by the peripheral data bus, and
the comparator compares the data output from the predetermined operation mode setting register through a signal line different from the peripheral data bus with the data output from the test register through a signal line different from the peripheral data bus.

5. The microcomputer according to claim 1, wherein
the data set in the test register during the write operation is set in all the operation mode setting registers in a next cycle to the write operation.

6. A microcomputer comprising:
a central processing unit (CPU) that executes instructions;
an instruction storage memory that stores the instructions to be executed by the CPU;
at least one of operation mode setting registers each in which an operation mode for a peripheral module is set;
a bus interface unit connected to the instruction storage memory by a memory bus, and connected to the operation mode setting registers by a peripheral bus;
a first test register connected to the bus interface unit by a dedicated data bus; and
a second test register connected to the bus interface unit by a peripheral data bus of the peripheral bus, wherein
the CPU executes a write operation in accordance with a write instruction to set data in predetermined one of the operation mode setting registers while a peripheral enable signal is asserted, and then outputs a signal for asserting the peripheral enable signal for two more cycles after the write operation is executed,
during the write operation, the CPU sets identical data in the predetermined operation mode setting register and the first test register, and the first test register sets inverted data of the data set therein in the second test register,
the second test register outputs the set data onto the peripheral data bus during a read operation in a next cycle to the write operation, and
the predetermined operation mode setting register outputs the set data onto the peripheral data bus during a read operation in a further next cycle to the write operation.

7. The microcomputer according to claim 6, wherein
the first test register outputs the data set during the write operation onto the dedicated data bus in a read cycle in which the predetermined operation mode setting register outputs the set data onto the peripheral data bus, and wherein
the microcomputer further comprises:
a comparator that compares the data output onto the peripheral data bus by the predetermined operation mode setting register with the data output onto the dedicated data bus by the first test register, and outputs an interrupt request signal to the CPU if a result of the comparison indicates data inconsistency.

8. The microcomputer according to claim 6, wherein
the first test register is connected to the peripheral data bus, and
the comparator compares the data output from the predetermined operation mode setting register through a signal line different from the peripheral data bus with the data output from the first test register through a signal line different from the peripheral data bus.

9. The microcomputer according to claim 6, wherein
the data set in the first test register during the write operation is set in all the operation mode setting registers in a next cycle to the write operation.
